(19) United States
(12) Patent Application Publication
(10) Pub. No.: US 2008/0314512 A1
(43) Pub. Date: Dec. 25, 2008

(54) Device and Method for Coating a Metallic Support Material

(75) Inventor: Peter Bartsch, Burgthann (DE)

Correspondence Address: JORDAN AND HAMBURG LLP, 122 EAST 42ND STREET, SUITE 4000, NEW YORK, NY, 10168, US

(73) Assignee: BILLHÖFER MASCHINENFABRIK GMBH & CO.KG, Numberg (DE)

(21) Appl. No.: 11/885,313

(22) PCT Filed: Jan. 19, 2006
(86) PCT No.: PCT/DE06/00085

§ 371 Date: Sep. 20, 2007

(30) Foreign Application Priority Data
Apr. 1, 2005 (DE) 10 2005 015 295.3

(51) Int. Cl. B29C 65/14; B29C 65/16; B29C 65/52; B32B 37/10

(52) U.S. Cl. 156/258; 156/538; 156/578; 156/379.8; 156/510; 156/459; 219/121.68; 156/324; 156/275.5; 156/256

(57) ABSTRACT

Apparatus for coating a metal support material with a coating material in the form of a web, having a feed device (4) for feeding the support material to a coating bay and having a coating roller (7) cooperating with a counter-pressure roller (8) in order to adhere the metal support material and the coating material in the form of a web to one another by applying pressure forces, by means of an adhesive.

The invention relates to apparatus and a method for coating a metal support material with a coating material in the form of a web.

For coating metal support materials, e.g. metal plates with a coating material in order to change the surface of the metal plates optically or haptically on one or both sides, various apparatuses and methods are known. For example, in the manufacture of painted or printed metal plates, paints or printing inks are used which are UV-reactive or solvent-containing. In the manufacture of metal packagings, e.g. screw caps for jars or bottles, crown caps, technological containers, food and aerosol containers and in a large number of other products manufactured from painted and printed metal such as toys or ornamental beading etc., problems affecting the environment are growing more and more important. These problems are on the one hand caused by the solvents contained in the paints and printing inks, and in other applications the need for food compatibility leads to particularly expensive apparatus.

In conventional methods, in a first operation one side of a metal plate is coated with a base paint for subsequent printing, in which case drying in the case of solvent-based paints is carried out thermally by means of technologically very complex, bulky, high-cost drying kilns. In these plants, the energy consumption is particularly high, and in addition heavy investments are necessary. The metal plates are conventionally transported in a virtually vertical position, then in a second, separate, also very expensive operation what is known as the protective painting of the other side of the metal plate takes place. In a third, also expensive separate operation, the metal plates are printed on one side followed by again an expensive thermal drying operation. A protective or high-gloss paint, which is applied to the printing ink, requires a further separate processing stage with a high cost comparable to that of base paint application.

In the use of UV-reactive paints and inks also conventional in the prior art, similar processing stages are necessary, and drying of the paints and printing inks is carried out with a high energy consumption and cost-intensive UV irradiation of the metal plates.

An increasing problem in the processing of solvent-containing paints and inks is the emission of volatile organic compounds, since in order to meet the increasingly production-limiting emission stipulations, increased costs are involved. In addition, conventional painting plant is characterised by a large space requirement.

The object of the invention is therefore to create apparatus for coating a metal support material with a coating material in the form of a web, which is more simply constructed and permits coating which is compatible with the environment.

To achieve this, in apparatus of the type mentioned in the introduction it is provided according to the invention that it has a supply device for supplying the support material to a coating bay and a coating roller cooperating with a counter-pressure roller in order to adhere the metal support material and the coating material in the form of a web by means of an adhesive and by applying pressure forces.

Unlike in conventional apparatus, the metal support materials are joined by an adhesive to the printed or non-printed coating material, and accordingly solvent-containing paints and inks can be completely dispensed with. The apparatus according to the invention has a comparatively simple construction, since expensive painting or printing plant can be omitted, which would normally cause high costs and a high energy consumption.

The apparatus according to the invention is particularly suited to the coating of plate-like support materials, in particular rectangular and format blanks, e.g. scroll plates, which can be coated end to end with scroll toothing or in an “underlapping” or overlapping manner. Adjacent scroll plates preferably have complementary, mutually abutting edges cut to shape. These support materials can be fed in stacks to the apparatus, the support material can be detached by an unstacking device, and can be conveyed one after another through the various processing bays of the apparatus according to the invention. The support materials typically have a GSM of 800-3,000 g/m².

Preferably the apparatus according to the invention has an alignment bay for aligning the plate-shaped support materials. The alignment bay can align the support materials in the direction of motion, i.e. in the longitudinal direction and/or in the lateral direction. Thus in all cases, registered alignment of the coating material can be achieved, even if the stacked support materials do not lie exactly in the position provided.

According to an advantageous extension of the apparatus according to the invention, the support materials can be imbricated one over another or under another by the alignment bay, with an adjustable degree of imbrication of the plates one under or over another. Alternatively, the support materials can be aligned end to end or with an adjustable gap by the alignment bay.

In the apparatus according to the invention, a slot nozzle can be provided for applying the adhesive. This slot nozzle can be omitted in other embodiments if the support material and/or the coating material is/are already provided with an adhesive. In this case, the adhesive previously applied can be thermally activated or reactivated.

It is advantageous if the quantity and/or the width of the adhesive to be applied can be adjusted by the slot nozzle. Thus the adhesive application can be adapted exactly to the support materials and coating materials used.

In the apparatus according to the invention, the adhesive can be applied by the contact method or non-contact method.

The apparatus according to the invention is particularly good for the processing of thermoplastic or reactive hot melt adhesives.

In the apparatus according to the invention the coating material can be passed in the region of the slot nozzle over a non-driven roller and with the adhesive-coated side over a driven release roller. The release roller acts as a withdrawing calender for the coating material in the form of a web and may be heatable or coolable. In addition the surface of this release roller can have a non-stick coating. The release roller receives in a controlled manner the adhesive coated side of the coating material wrapped round it and releases the same with controlled tension of the coating material for feeding to the next coating roller.

It is within the scope of the invention that the apparatus has one or more tempering devices acting on the coating material and/or on the lower face and/or the upper face of the support material in order to heat the materials to a specified processing temperature.

A particularly large field of application is obtained with the apparatus according to the invention if the counter-pressure roller has adjustable pressure. It is particularly advantageous if the counter-pressure roller has a rubberised surface or a non-stick coating.

It can be provided that the apparatus has a conveying device, for the coated support material in the form of a web, disposed behind the coating bay in the direction of motion. It is particularly preferred that the conveying device has a suction belt, with which a particularly good hold of the support materials is ensured.

As a further option the apparatus according to the invention may have a UV irradiation device for irradiating reactive adhesives which cross-link with radiation. The UV irradiation is carried out after adhesion and pressing of the metal support material to the coating material in the form of a web.

In order to separate the plate-shaped support materials again following coating, a device for separating can be provided, and furthermore the separated support materials can be conveyed by a conveying apparatus having a suction belt, in which case it is particularly advantageous if the support materials are conveyed to a stacking device, which is suitable for stack weights of up to 3,500 kg.

The apparatus according to the invention may have a register control for the registered application of the coating material to the support material. By register control, electronically scannable identification marks applied to the coating material are detected in order to place the coating material exactly on the support material. Alternatively or additionally, by register control, an edge of the support material can also be detected. The feeding of the metal support materials is at the same time controlled so as to be adapted thereto.

In a further embodiment of the invention it may be provided that in the coating bay coating materials in the form of webs are applied bilaterally to the metal support material. To this end, a second slot nozzle can be provided, but it is also possible that an activation station is provided, by means of which the coating material is thermally activatable at least on one side of the support material.

The apparatus according to the invention may have a cutting bay for the coating material, which is disposed in front of the coating bay in the direction of motion. With this coating bay, the coating material can be trimmed at the sides or notches can be made in the longitudinal direction before the coating material reaches the coating bay.

In addition, the apparatus according to the invention may have a separation bay, disposed behind the coating bay in the direction of motion, for the coating material. In this manner, a wide strip of coating material can be cut to the contour of a narrower or individually shaped metal support material.

In a further embodiment of the invention, a cutting bay disposed behind the detaching device in the direction of motion can be provided in order to trim the front and/or rear edge of coated support materials. This cutting bay can then be used if the metal support materials are produced in end to end abutment with a specified distance between the individual supports. The cutting bay may have blades and/or a laser for this purpose.

Alternatively to the processing of metal plate-shaped support materials, the apparatus according to the invention can also be so formed that it is suitable for coating metal support materials in web form. In this case, web-like metal support materials in the form of coils are used, which are provided with the coating material and then wound back on to a reel in a winding apparatus. Alternatively, the support materials in the form of a web may however be detached in a cutting device so that they leave the apparatus according to the invention as coated, plate-shaped support materials. This cutting bay may have blades and/or laser. The laser is capable of producing cuts with any contour, in particular the laser is suitable for scroll plate contour cuts.

It is particularly preferred that the apparatus is suitable for the coating materials: foil, textile, paper or leather. These coating materials can be used in the printed or non-printed form.

In addition the invention relates to a method of coating a metal support material. In the method according to the invention it is provided that the support material is supplied by means of a supply device to a coating bay, in which it is guided through a gap formed between a counter-pressure roller and a coating roller and is adhered by means of an adhesive to the coating material in the form of a web under the action of the pressure forces generated by the rollers.

Further embodiments of the invention will appear from the subclaims.

Further advantages and details of the invention will be explained by means of embodiments with reference to the drawings, which are diagrammatic representations and show:

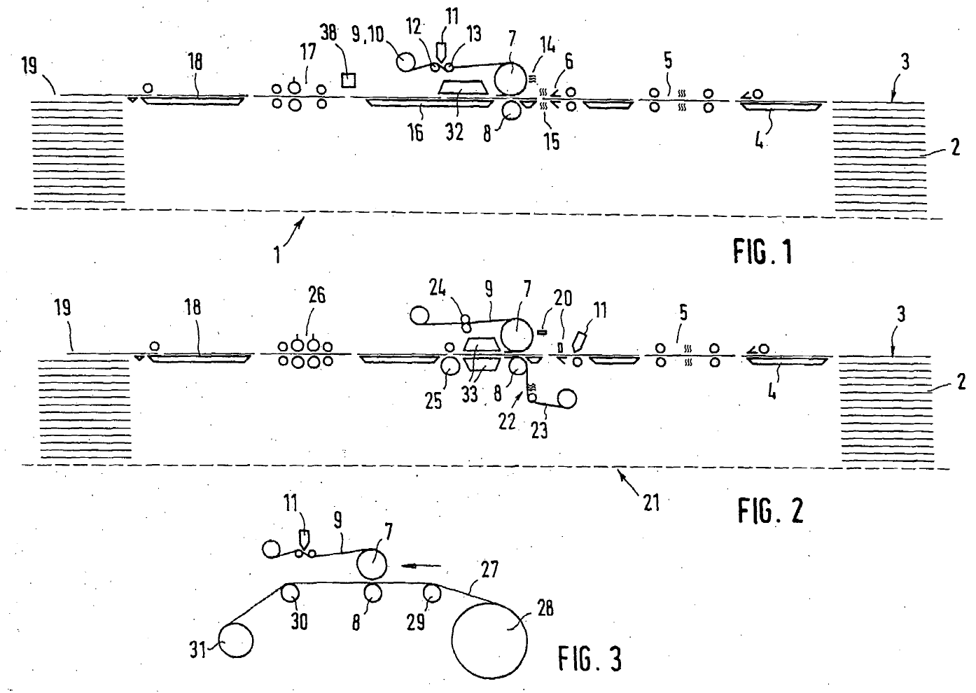

FIG. 1 a first embodiment of an apparatus according to the invention for coating a metal support material;

FIG. 2 a second embodiment of an apparatus according to the invention;

FIG. 3 a third embodiment of the invention; and

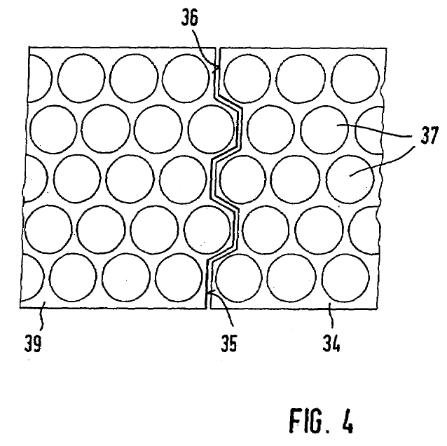

FIG. 4 two support materials formed as scroll plates.

The apparatus shown in FIG. 1 is suitable for coating support materials, which are formed as metal plates and consist of aluminium or tinplate. Plates consisting of tinplate may be zinc-, tin- or chromium-plated. Obviously, metal plates consisting of other alloys can also be processed with the apparatus 1. Typical plate thicknesses are 0.1-0.5 mm.

The metal plates 2 are stacked horizontally in an unstacking device 3 and are fed to the apparatus 1. Within the scope of the coating operation, the metal plates 2 are conveyed substantially horizontally through the apparatus 1, and in the view shown in FIG. 1 the metal plates 2 are conveyed from right to left. The conveying of the metal plates 2 is effected by a feed device 4, which has a suction belt, with which the metal plates 2 are conveyed on one after another. The unstacking of the metal plates 2 takes place in cycles, the top metal plate being removed with a suction head and the stack being raised accordingly. The conveying of the individual metal plates 2 is effected either with end to end abutment, in which case also a specified distance may be provided between the individual metal plates, or alternatively the metal plates can be conveyed in the form of an imbricated stream of plates which overlap or “underlap” via the suction belt.

Via an alignment bay not shown in FIG. 1, each metal plates is aligned in a controlled manner, which means that it is positioned laterally and in the longitudinal direction, so that either identical gaps are formed between individual metal plates or an identical overlap or “underlap” is present.

In certain embodiments, an apparatus can be provided which changes the imbricated stream in the region of the overlap into an underlap by lifting the trailing plates and lowering them on to the leading plates.

Following the feed device 4, the metal plates are fed to a cleaning bay 5. The cleaning bay 5 has intake rollers and is so formed that one or both sides of the metal plates is/are cleaned. Cleaning can be effected mechanically, e.g. by brushes, thermally, e.g. by infrared radiation, or chemically, e.g. by liquid cleaning agents. Alternatively, the cleaning can be effected by radiation technology by corona treatment. By this cleaning process, any residues due to production left on the surfaces of the metal plates are removed. By using corona treatment, at the same time the surface tension of the metal plates is increased to the level necessary for optimum adhesion of the adhesive.

Following the cleaning bay 5, the cleaned metal plates reach an alignment bay 6, which aligns the individual plates adjustably, so that the plates pass into the gap between a coating roller 7 and a counter-pressure roller 8 in a specified manner. Thus the individual plates are exactly aligned on the coating material. The plates are precisely aligned relative to the front edge and one side edge, and simultaneously an adjustable degree of overlap or underlap or end to end clearance can be realised. The overlap or underlap can be 1 to 15 mm, the end to end clearance can be 0 to 15 mm.

The coating material 9 in this embodiment in the form of a foil is present as a roll and is located on a tension shaft 10 which is pivotable for the purpose of loading. The web guiding of the brake-controlled or driven coating material 9 is effected via various rollers until the coating gap is reached, which is formed by the coating roller 7 and the counter-pressure roller 8.

The application of adhesive to the coating material 9 is effected via a slot nozzle 11. Such slot nozzles are known per se and comprise an adhesive reservoir with a melting device, heatable supply and return hoses, a nozzle antechamber with metering pumps, the slot nozzle proper with segments and an application lip with an application width adjustment and electronic control.

With the slot nozzle 11, at a typical adhesive temperature of approx. 80 to 200° C., adhesive application quantities of about 0.5 to 20 g/m² can be realised. The application of the adhesive is effected according to the setting, the distance and the pivot angle of the nozzle lip to the coating material selectively in direct contact of the nozzle lip with the coating material (contact method) or at a distance of about 1 to 5 mm from the coating material (non-contact method), in which case at these settings a closed film of adhesive corresponding to the application width set is discharged over the whole area or part thereof from the nozzle lip on to the coating material and is taken up thereby.

As adhesives, thermoplastic or reactive hot melt adhesives are suitable.

The hot melt adhesives are selected according to the substrates to be adhered and the requirements associated therewith, e.g. a required temperature resistance or heat resistance of the adhesion etc.

As purely thermoplastic hot melt adhesives, in particular those with a base of ethylene-/vinyl acetate (EVA), polyolefins (e.g. amorphous poly-α-olefins, metallocene-catalysed polyolefins), polyacrylates, co-polyamids, co-polyesters and/or thermoplastic polyurethanes or corresponding co- and/or terpolymers are used.

As reactive hot melt adhesives which are e.g. cross-linking by humidity, those are used which in particular have a base of silane-plugged amorphous poly-α-olefins or isocyanate-terminated polyurethanes. In the case of reactive hot melt adhesives, the subsequent cross-linking with humidity leads to temperature- or heat-resistant adhesions. Reactive hot melt adhesives thus combine the advantages of rapid initial strength due to the physical hardening process of cooling with subsequently occurring chemical cross-linking. In the processing of hot melt adhesives which are reactive with humidity, the melt must be protected from moisture before its application.

For example, for laminating metal plates or metal sheets with OPP foils (oriented polypropylene foil) or PET foils (polyester foils) in the form of being printed on the back or non-printed in combination with a high temperature-resistance of the composite, hot melt adhesives with a base of silane-plugged polyolefins are used.

Polymers which are suitable within the scope of the present invention for reactive hot melt adhesives cross-linking in humidity are for example the silane-modified poly-α-olefins obtainable commercially under the product name “Vestoplast® 206” by the firm Degussa A G, Marl, Germany.

Further suitable reactive hot melt adhesives comprise reactive adhesives cross-linking with radiation (e.g. reactive hot melt adhesives which cross-link under UV radiation).

The application of the adhesive can be carried out over a wide temperature range. Generally, processing temperatures in the range of 80° C. to 200° C. are selected.

In order to achieve good applicability of the hot melt adhesive, generally those hot melt adhesives are used which at the processing temperatures generally of 80° C. to 200° C., have Brookfield viscosities in the range of generally 50 to 1,000,000 mPa·s.

For example, preferably reactive hot melt adhesives with a base of silane-plugged polyolefins, in particular silane-plugged amorphous poly-α-olefins are used, which have Brookfield viscosities at 180° C. in the range of 50 to 50,000 mPa·s, in particular 1,000 to 10,000 mPa·s, preferably 5,000 to 8,000 mPa·s, and particularly preferably 5,500 to 7,500 mPa·s.

To control the reactivity and cross-linking behaviour, generally the conventional catalysts are added to the reactive hot melt adhesives, thus for example dibutyl tin laurate (DBTL), and this in the quantities conventional per se for these purposes.

To control the open time and/or the adhesion properties of the above-mentioned hot melt adhesives, in particular also in terms of improved handling, furthermore, additives may be added to the above-mentioned hot melt adhesives, these additives being in particular non-reactive polymers (e.g. unmodified amorphous poly-α-olefins), non-reactive resins (e.g. hydrocarbon resins) and/or non-reactive waxes. Thus the adhesive properties can be set according to the application and tailored as it were.

As a coating material 9, various materials are conceivable, e.g. textile, paper or leather, and preferably the coating material is a plastics foils with a material thickness of about 5 to 250 μm, and more preferably the thickness of the foil is 10-25 μm.

Below the nozzle lip of the slot nozzle 11, a roller pair is disposed, through whose gap the coating material is drawn, and at the same time the application of the adhesive takes place. This roller pair also acts as a drawing-off calender and consists of a first, non-driven pressure-adjustable roller 12 and a second non-stick-coated heatable and coolable release roller 13. The release roller 13 is operated with a lead of 3 to 10% to the coating roller 7 and is connected to a controllable drive. The adhesive-coated side of the coating material in the form of a web 9 wraps round the release roller 13 up to a run-off point which may be set by sensors, whereupon the web tension of the coating material 9 after leaving the release roller 13 until the gasp formed between the coating roller 7 and the counter-pressure roller 8 may be so set according to the type and strength of the coating material 9 that a tension is avoided which might stretch or deform the coating material 9. This is particularly important in the registered coating of metal plates, e.g. if a printed image is positioned on the coating material formed as a foil.

The coating material in the form of a web 9 coated with adhesive substantially wraps round the coating roller 7 on its web-guided path and according to the type of adhesive used and the consequent processing temperature of the adhesive is cooled or heated by the coating roller 7.

If a coating material is used which is already provided with a thermally reactivatable coating suitable for adhesive, this coating material is passed in the same way through the apparatus, but the application of adhesive by the slot nozzle is omitted. The thermal reactivation of the coating suitable for adhesive is effected indirectly by tempering of the coating material by the coating roller 7. To this end, the coating roller 7 can be tempered from 20 to 200° C. in an infinitely variable manner.

According to the type and quality of coating material, the adhesive used or the coating suitable for adhesive of the coating material, as is shown in FIG. 1, tempering devices 14, 15 acting by irradiation or acting on contact can be used, which may temper the temperature of the coating material 9 and/or of the upper face and/or lower face of the metal support materials by induction or infrared radiation.

The joining of the adhesive-coated coating material 9 in the form of a web to the metal plate aligned on the coating material is effected by the pressure of the counter-pressure roller 8, which may be adjusted infinitely variably, acting on the coating roller 7. This pressure may be set infinitely variably in the region of about 5,000 to 60,000 N. The counter-pressure roller 8 has a rubberised or non-stick-coated surface. The counter-pressure roller 8 can be formed as a cooled roller and have a temperature of about 10 to 30° C. In addition, the counter-pressure roller 8 can be formed as a driven roller, so that in the case of thin metal support materials improved flatness is achieved.

Optionally, in the processing of reactive adhesives cross-linking by radiation, after the passage through the coating apparatus, a UV irradiation apparatus 32 can be used for an upper and optionally a lower web of the coating material 9.

Following the coating, the stream of metal plates 2 coated with the coating material 9 and connected thereby is fed overlapping or underlapping or in end to end abutment to a separating device 17 in a horizontal manner by means of a conveyor apparatus 16 having a suction belt.

The severing of the coating material 9 at an adjustable point in the region of the overlap or underlap or in the abutment-region is carried out by a separating blade according to the type and thickness of the coating material. This separating blade is formed as a rotary cutting blade and is controlled in such a manner that at the moment of separation it is running synchronously with the web speed of the coating material. The blade can be formed as a cold or heated blade, and it is also conceivable to use a blade operating in a reciprocating manner transverse to the web. As a further alternative, the separation of the coating material can be effected by a laser, in which case one or more laser beams determine the entire cut region. In the case of a support material coated on both sides, the severing of the coating material is effected by an additional arrangement of one of the above-mentioned separating devices on the underside of the stream of metal plates. The separating device 17 is controlled via a computer means, the respective length of the metal plates, the position of the desired cut point and the speed of the coated metal plates being taken into account.

In combination with the separating device 17, even before separation of the coating material an etching bay 38 can be provided by means of one or more lasers, with which transverse or longitudinal recesses can be formed e.g. in the case of synthetic coating material. In this case, the laser beams burn the coating material along programmable contours on to the metal plates with line widths of 0.1-7.0 mm. Vapours produced in this operation are drawn off.

After separation of the coated support material, this is conveyed via a drawing-off roller pair with an adjustable lead of about 3 to 20% from the separating device 17 to a downstream acceleration conveyor belt 18 for individual plates.

The conveyor belt 18 leads the separated, coated support materials to a downstream simple or multiple stacking device 19, each plate being reduced in its forward feed rate by a vacuum brake shortly before it reaches the stop point for lowering on to the stack, in order to permit stacking which is free from damage to the plates.

FIG. 2 shows a further embodiment of the invention. Identical components are in this case referenced with the same reference numbers as in the first embodiment. Corresponding to the first embodiment, the metal plates 2 are fed by the unstacking device 3 of the feed apparatus 4, followed by the cleaning bay 5. Depending on the type and thickness of the coating material 9 in the form of a web, it may be necessary not to subject the coating material to thermal stress with the adhesive, but to coat the metal plates with adhesive before they enter the coating gap. As is shown in FIG. 2, the adhesive is applied by the slot nozzle 11 direct on to the metal plates. The slot nozzle 11 and the associated units are to this end disposed above the horizontally moving metal plates.

In order to achieve a registered transfer or adhesion of the coating material 9 in the coating gap on to the metal plates by controlled supply of the metal plates to the printed pattern of the coating material 9, a register control 20 is provided, which is shown diagrammatically in FIG. 2. An exact positioning is achieved by the register control 20 particularly in those applications in which the coating material is formed as a printed foil and has plural images on an area corresponding to the dimension of one metal plate. To process further, the subsequently detached coated metal plates are fed to a punching device, wherein the metal plate is aligned at the plate front edge and plate side edge. In this case, the printed image of the foil on the metal plate must correspond exactly to the permanently fixed punching tool.

For the coating of the insides of tins or containers etc., thin plastics foils can be used, which are equipped with a thermally reactivatable adhesive coating as coextruded foils. In order to achieve bilateral coating of the metal plates 2, the device 21 shown in FIG. 2 has a reactivation bay 22, in which a coating material 23 formed as a foil disposed on a roll is thermally activated and then passes into the gap formed between the coating roller 7 and the counter-pressure roller 8. Thus a simultaneous, bilateral coating of the metal plates is made possible. With the device 21 shown in FIG. 2, plural narrow coating materials in the form of webs can be processed, which are connected to the metal plates. The coating material is in this case supplied in roll form and is cut to size as plural narrow material webs at a cutting bay 24 by way of longitudinal cuts. Thus a web of coating material which is unwound with the full width of the metal plates and coated in plastics material, the portions of the coating material cut out being drawn off by suction or wound up. In addition, the cutting bay 24 can also be used to carry out trimming cuts on the coating material 9.

Behind the roller pair 7, 8 in the direction of motion is a UV irradiation device 33, which acts on both sides of the coated support material in order to trigger cross-linking in the case of reactive adhesives.

If a metal plate is coated with a coating material whose breadth exceeds the breadth of the metal plate, by means of a separation bay 25, cutting of the coating material 9 to correspond to the contour of the metal plate can be carried out. To this end, a rotary tool heated at the separation points and corresponding to the desired contour is used. The separated coating material is received by a counter-roller by the adhesion force of the adhesive on the underside of the separated coating material.

According to the respective application, it may be necessary to coat with coating material metal plates in end to end abutment with a gap of up to 15 mm from one metal plate to another. In order to detach metal plates so coated without having coating material projecting along the sides, a dual separating cut is necessary. After carrying out a first separating cut, which is effected similarly to the separating device 17 shown in FIG. 1, in the device 21 shown in FIG. 2 a first and a second separating cut is made by a separating device 26. The separating device 26 additionally has a second rotary blade or another separating device, possibly a laser. The separated strip of coating material is drawn off by suction after carrying out the cut. The conveying of separated metal plates is effected as in the first embodiment by a conveyor belt 18 to a stacking device 19.

FIG. 3 shows a further embodiment of the invention in which a metal support material is used in web form. The support material 27 in the form of a web is wound on a roll 28, which is referred to as a coil. The support material 27 is passed via a guide roller 29 into the coating gap, which is formed between the coating roller 7 and the counter-pressure roller 8.

Corresponding to the embodiment shown in FIG. 1, the coating material in the form of a web 9 is provided with adhesive by the slot nozzle 11 and is passed over the coating roller 7 for tempering, then the coating material 9 and the support material 27 in the form of a web are joined together by the pressure forces generated by the roller pair 7, 8 and are wound on to a roll 31 via a guide roller 30.

Alternatively, a cutting unit for the support material 27 provided with coating material 9 can be used to cut the metal web into individual plates.

Preferably, support materials are used in the form of rectangular or format blanks, in particular also scroll plates. FIG. 4 shows two adjacent scroll plates 34, 39. What is known as the scrolling is a shaping cut 35, 36 carried out on two opposite sides of the plate-shaped support material and having a serpentine contour. The two longitudinal sides of the plates 34, 39 have a smooth edge. Scroll plates are used for example in order to manufacture round products such as screw-on lids or the like. The contour of the circular lids 37 is printed on the coating material and is so positioned on the plates that adjacent rows are staggered with respect to one another by half the distance between two centre points of the circles, in order to achieve optimum utilisation of the plate. The area missing on one side of the scroll plate is located on the opposite side of the scroll plate, and thus the material is optimally utilised. The separation of the coating material is effected by means of the etching bay 38.

1. Apparatus for coating a metal support material with a coating material in the form of a web, comprising a feed device for feeding the support material to a coating bay and a coating roller cooperating with a counter-pressure roller in order to adhere together the metal support material and the coating material in the form of a web by applying pressure forces and by means of an adhesive.

2. Apparatus according to claim 1, wherein plate-shaped support materials are coated, in particular in the form of rectangular and format blanks, e.g. scroll plates, wherein adjacent scroll plates preferably have complementary, mutually abutting sides cut to shape.

3. Apparatus according to claim 2, comprising an unstacking device for detaching support materials supplied in the form of a stack.

4. Apparatus according to claim 2 comprising an alignment bay for aligning the plate-shaped support materials.

5. Apparatus according to claim 4, wherein the support materials can be aligned by the alignment bay in the direction of motion and/or laterally.

6. Apparatus according to claim 4 wherein the support materials can be aligned by the alignment bay so as to underlap or overlap one another by an adjustable amount.

7. Apparatus according to claim 4 wherein the support materials can be aligned by the alignment bay end to end or with an adjustable gap.

8. Apparatus according to claim 1, comprising a slot nozzle for applying the adhesive.

9. Apparatus according to claim 8, wherein the quantity and/or width of the adhesive to be applied is adjustable.

10. Apparatus according to claim 1, wherein the adhesive may be applied by the contact method or by the non-contact method.

11. Apparatus according to claim 1, wherein the adhesives comprise thermoplastic or reactive hot melt adhesives.

12. Apparatus according to claim 8, wherein the coating material may be guided in the region of the slot nozzle over a non-driven roller and with the adhesive-coated side over a driven release roller.

13. Apparatus according to claim 1, wherein the coating roller may be heated or cooled.

14. Apparatus according to claim 1, comprising one or more tempering devices acting on the coating material and/or on the upper face and/or the lower face of the support material.

15. Apparatus according to claim 1, wherein the counter-pressure roller is pressure-adjustable.

16. Apparatus according to claim 1, wherein the counter-pressure roller has a rubberised surface or a non-stick coating.

17. Apparatus according to claim 1, comprising a conveying device for the coated support material in the form of a web, which device is disposed behind the coating bay in the direction of motion.

18. Apparatus according to claim 17, wherein the conveyor device is a suction belt.

19. Apparatus according to claim 1, comprising a UV irradiation device for irradiating reactive adhesives cross-linking by radiation.

20. Apparatus according to claim 1, comprising a device for separating the support materials which are provided with the coating material and which are in the form of a web.

21. Apparatus according to claim 20, comprising a conveying device having a suction belt for conveying the support materials after detachment thereof.

22. Apparatus according to claim 1, comprising an etching bay which preferably has at least one laser in order to generate recesses in the coating material in the transverse and/or longitudinal direction.

23. Apparatus according to claim 1, comprising a stacking device for the coated support materials or is coupled or is capable of being coupled to a stacking device.

24. Apparatus according to claim 1, comprising a register control for the registered application of the coating material to the support material.

25. Apparatus according to claim 1, comprising a cleaning bay for the metal support materials disposed in front of the coating bay in the direction of motion, in order to subject the support materials to corona treatment for setting and increasing the surface tension.

26. Apparatus according to claim 1, wherein the coating bay coating materials in the form of webs may be applied bilaterally to the metal support material.

27. Apparatus according to claim 26, comprising a thermal activation or reactivation bay is provided, with which the coating material may be thermally activated at least on one side of the support material.

28. Apparatus according to claim 1, comprising a cutting bay for the coating material, disposed in front of the coating bay in the direction of motion.

29. Apparatus according to claim 1, comprising a separating bay for the coating material disposed behind the coating bay in the direction of motion.

30. Apparatus according to claim 20, comprising a separating device disposed behind the device for detachment in the direction of motion in order to trim the front and/or rear edge of coated support materials.

31. Apparatus according to claim 1, comprising coating metal support materials in the form of a web.

32. Apparatus according to claim 31, comprising a winding device for the coated support materials in the form of a web.

33. Apparatus according to claim 31, comprising a cutting device for detaching the coated support materials in the form of a web.

34. Apparatus according to claim 1, wherein the coating materials comprises foil, textile, paper or leather.

35. Apparatus according to claim 1, wherein the coating materials comprise printed or non-printed coating materials.

36. Method of coating a metal support material with a coating material in the form of a web, comprising feeding the support material by means of a feed device to a coating bay in which it is passed through a gap formed between a counter-pressure roller and a coating roller and under the effect of the pressure forces generated by the rollers is adhered to the coating material in the form of a web by means of an adhesive.

37. Method according to claim 36, wherein the metal support materials are detached in an unstacking device.

38. Method according to claim 36, wherein the metal support materials are aligned in the direction of motion and/or laterally in an alignment bay.

39. Method according to claim 36, wherein the support materials are aligned by the alignment bay so as to be imbricated below one another or over one another with an adjustable degree of underlap or overlap.

40. Method according to claim 36, wherein the support materials are aligned by the alignment bay end to end or with a gap which may be set.

41. Method according to claim 36, wherein the adhesive is applied by a slot nozzle.

42. Method according to claim 36, wherein the adhesive is applied by the contact method or by the non-contact method.

43. Method according to claim 36, wherein the coating material and/or the upper face and/or the lower face of the support material is tempered by at least one tempering device.

44. Method according to claim 36, wherein a reactive adhesive which cross-links by radiation is irradiated by a UV irradiation device.

45. Method according to claim 36, wherein the support materials provided with the coating material and having the form of a web are detached.

46. Method according to claim 36, wherein the support materials and the coating material are controlled relative to one another in a registered manner by means of a register control.

47. Method according to claim 36, wherein the coating materials are applied to both sides of the support materials.

48. Method according to claim 36, wherein an adhesive previously applied to the coating material and/or the support material is thermally activated or reactivated.

49. Method according to claim 36, wherein the coating material is cut and/or trimmed and/or partly separated before coating.

50. Method according to claim 36, wherein at least one edge, preferably the front and/or rear edge of the coated support materials is trimmed.

51. Method according to claim 36, wherein a metal support material in the form of a web is used.

52. Method according to claim 36, wherein a printed or non-printed coating material is used.

53. Method according to claim 36, wherein a coating material in the form of a foil, textile, paper or leather is used.
